(19) United States
(12) Patent Application Publication
(10) Pub. No.: US 2016/0146173 A1
(43) Pub. Date: May 26, 2016

(54) Control System for an Automotive Engine and a Method of Controlling an Automotive Engine

(71) Applicant: CAP-XX LIMITED, Dee Why, New South Wales (AU)

(72) Inventors: Pierre Mars, Vaucluse, New South Wales (AU); David Elliott McIntosh, Eastwood, New South Wales (AU); Hao Huang, North Ryde, New South Wales (AU)

(73) Assignee: CAP-XX LIMITED, Dee Why, New South Wales (AU)

(21) Appl. No.: 14/901,439

(22) PCT Filed: Jun. 30, 2014
(86) PCT No.: PCT/AU2014/000685

§ 371 Date: Dec. 28, 2015

(30) Foreign Application Priority Data
Jun. 28, 2013 (AU) 2013902404
Jun. 28, 2013 (AU) 2013902405
Jun. 28, 2013 (AU) 2013902408

(51) Int. Cl. F02N 11/08

(52) U.S. Cl. CPC F02N 11/0814; F02N 11/0866

(57) ABSTRACT

An automotive engine (3) has a start-up state that occurs during a starting sequence and a nm state when operating normally. A starter unit, in the form of a motor (7), cranks the drive unit during the start-up state, and a first energy storage device, in the form of a supercapacitive device (8), supplies electrical energy to the motor (7) during the start-up state. A second energy storage device, in the form of a battery (5), supplies electrical energy selectively to the device (8) other than during the start-up state, and an electrical supply unit, in the form of an alternator (6), selectively supplies electrical energy during the run state to the device (8).

### FIELD OF THE INVENTION

The present invention relates to a control system for an automotive engine and a method of controlling an automotive engine.

Embodiments of the invention have been particularly developed to provide a stop/start system and a micro-hybrid system for an internal combustion engine used in a vehicle, and will be described herein with particular reference to those applications. However, it will be appreciated that the invention is not limited to such a field of use, and is applicable in broader contexts including, without limitation, hybrid engine vehicles, electrical engine vehicles and other driven devices.

### BACKGROUND

Any discussion of the background art throughout the specification should in no way be considered as an admission that such art is widely known or forms part of common general knowledge in the field.

It is known to incorporate stop/start functionality into a car or other vehicle with an internal combustion engine having an electronic engine management system (EMS). This typically involves the EMS being automatically responsive to the car slowing down sufficiently or stopping to turn the internal combustion engine off. That is, the EMS automatically controls the engine to be in an “off” or “stopped” state. This state may occur as the car stops in heavy traffic or a traffic jam, or when a car is stopped at traffic lights. The EMS is also automatically responsive to the driver of the car pressing the accelerator or other controls to re-start the engine and to commence movement once again of the vehicle. That is, the EMS recognises the input from the driver so the driver does not have to be aware the engine stopping and starting as the car comes to a halt or moves from such a halt.

The rationale for using such stop/start technologies is to minimise the need for the engine to idle when the car is stopped and, hence, to reduce the consumption of fuel and reduce the production of pollution. It has been estimated in some studies that the use of stop/start technology in a car, when applied to typical city driving, may be able to reduce pollution and fuel use by up to 15%.

Cars include electrochemical batteries for providing a store of energy to allow starting of the engine. By far the most popular battery for cars is a lead acid battery. A major downside with stop/start technologies is that the battery must start the engine many more times than in a vehicle without such stop/start technology. The conventional solution for cars with stop/start technology is to include either one or more additional lead acid batteries in the car or a much larger capacity lead acid battery. However, to provide sufficient capacity to accommodate stop/start technologies, these batteries add considerable cost and weight to the car. An alternative is to make use of a capacitive device in parallel with the battery, although this has so far proved unpopular due to the relatively high leakage current that is found in capacitors that offer suitable combinations of high capacitance, low volume and low price.

Whilst in this specification use is made of the term “stop/start” to describe the above and similar functions, it will be appreciated that this is synonymous and interchangeable with any one of the following or like terms: start/stop; stop-start; start-stop; and other such terms used to refer to this type of technology.

### SUMMARY OF THE INVENTION

It is an object of the present invention to overcome or ameliorate at least one of the disadvantages of the prior art, or to provide a useful alternative.

According to a first aspect of the invention there is provided an automotive drive including:
a drive unit for providing drive to a drive-train, the drive unit having a start-up state and a run state;
a starter unit for cranking the drive unit during the start-up state;
a first energy storage device for supplying electrical energy to the starter unit during the start-up state;
a second energy storage device for supplying electrical energy selectively to the first energy storage device other than during the start-up state; and
an electrical supply unit for selectively supplying electrical energy during the run state to the first energy storage device.

In an embodiment the electrical supply unit selectively supplies electrical energy during the run state to the second energy storage device.

In an embodiment the second energy storage device selectively supplies electrical energy to the first energy storage device prior to the start-up state.

In an embodiment the drive unit is an internal combustion engine and the electrical supply unit is an alternator that is mechanically driven by the engine during the run state.

In an embodiment the first energy storage device is one or more supercapacitive devices.

In an embodiment the one or more supercapacitive devices include at least one double layer supercapacitor.

In an embodiment the second energy storage device includes at least one electrochemical energy storage device.

In an embodiment the at least one electrochemical energy storage device is one or more electrolytic battery.

In an embodiment the one or more electrolytic battery is a lead acid battery.

In an embodiment the drive unit includes a stop state where it is not providing drive to the drive train, and the automotive drive includes a stop/start controller for selectively progressing the drive unit between the states.

In an embodiment the stop/start controller progresses the drive unit from the run state to the stop state; from the stop state to the start-up state; and from the start-up state to the run state.

In an embodiment the drive unit includes an internal combustion engine.

In an embodiment the drive unit includes one or more electric motors.

In an embodiment the automotive drive includes an electrical load that draws current from the electrical supply unit during the run state.

In an embodiment the electrical load draws current from the second energy storage device during the stop state.

In an embodiment the electrical load draws current from the second energy storage device during the start-up state.

According to a second aspect of the invention there is provided an automotive engine including:
a drive unit for providing drive to a drive-train, the drive unit having a stop state, a start-up state and a run state;
an electrical load that draws electrical energy during one or more of the states;
a supercapacitive device;
an electrochemical device for supplying electrical energy to the electrical load during the stop state and for selectively supplying electrical energy to the supercapacitive device other than during the start-up state;
a starter motor for drawing electrical energy from the supercapacitive device for cranking the drive unit during the start-up state; and
an electrical unit that is driven by the drive unit for supplying electrical energy selectively during the run state to the supercapacitive device.

In an embodiment the electrical unit supplies electrical energy selectively during the run state to the electrochemical device.

In an embodiment the electrochemical device supplies electrical energy selectively to the electrical load during the stop state.

In an embodiment the electrochemical device supplies electrical energy selectively to the electrical load only during the stop state.

In an embodiment the electrochemical device selectively supplies electrical energy to the supercapacitive device prior to the start-up state.

In an embodiment the drive unit is an internal combustion engine and the electrical unit is an alternator or a starter-generator that is mechanically driven by the engine during the run state.

In an embodiment the supercapacitive devices include at least one electric double layer supercapacitor.

In an embodiment the electrochemical device is one or more electrolytic battery.

In an embodiment the one or more electrolytic battery is a lead acid battery.

In an embodiment, during the stop state, the drive unit is not providing drive to the drive train, and the engine includes a stop/start controller for selectively progressing the drive unit between the states.

In an embodiment the stop/start controller progresses the drive unit from the run state to the stop state; from the stop state to the start-up state; and from the start-up state to the run state.

In an embodiment the automotive engine includes an electrical load that draws current from the electrical unit during the run state.

In an embodiment the electrical load draws current from the electrochemical device during the stop state.

In an embodiment the electrical load draws current from the electrochemical device during the start-up state.

According to a third aspect of the invention there is provided a method of providing automotive drive including the steps of:
providing drive to a drive-train with a drive unit, the drive unit having a start-up state and a run state;
cranking the drive unit during the start-up state with a starter unit;
supplying electrical energy from a first energy storage device to the starter unit during the start-up state;
supplying electrical energy selectively from a second energy storage device to the first energy storage device other than during the start-up state; and
selectively supplying electrical energy from an electrical supply unit to the first energy storage device during the run state.

In an embodiment the electrical supply unit selectively supplies electrical energy during the run state to the second energy storage device.

In an embodiment the second energy storage device selectively supplies electrical energy to the first energy storage device prior to the start-up state.

According to a fourth aspect of the invention there is provided a method of operating a drive unit for providing drive to a drive-train, the drive unit having a stop state, a start-up state and a run state and an electrical load that draws electrical energy during one or more of the states, the method including the steps of:
providing a supercapacitive device;
supplying electrical energy from an electrochemical device to the electrical load during the stop state;
selectively supplying electrical energy from the electrochemical device to the first energy storage device other than during the start-up state;
drawing electrical energy from the supercapacitive device for cranking the drive unit during the start-up state; and
supplying electrical energy selectively to the supercapacitive device during the run state from an electrical unit that is driven by the drive unit.

According to a fifth aspect of the invention there is provided a control system for an automotive engine having a starter motor, an alternator, a start-up state, and a run state, the system including:
a memory module for storing executable code; and
a processor for accessing the module and being responsive to the code for generating:
a first control signal to actuate a starter motor to crank the engine during the start-up state, wherein the starter motor draws electrical energy from a supercapacitive device;
a second control signal to initiate the supply of electrical energy selectively from a battery to the supercapacitive device other than during the start-up state; and
a third control signal to initiate the selectively supply of electrical energy during the run state from the alternator to the supercapacitive device.

In an embodiment the electrical supply unit selectively supplies electrical energy during the run state to the second energy storage device.

In an embodiment the second energy storage device selectively supplies electrical energy to the first energy storage device prior to the start-up state.

In an embodiment the drive unit is an internal combustion engine and the electrical supply unit is an alternator that is mechanically driven by the engine during the run state.

In an embodiment the second energy storage device includes at least one electrochemical energy storage device.

In an embodiment the drive unit includes a stop state where it is not providing drive to the drive train, and the automotive drive includes a stop/start controller for selectively progressing the drive unit between the states.

In an embodiment the automotive drive includes an electrical load that draws current from the electrical supply unit during the run state.

In an embodiment the electrical load draws current from the second energy storage device during the stop state.

In an embodiment the electrical load draws current selectively from the second energy storage device during the start-up state.

In an embodiment the electrical load draws current selectively from the first energy storage device.

According to a sixth aspect of the invention there is provided a control system for an automotive engine having a starter motor, an alternator, a start-up state, and a run state, the system including:
a control circuit for generating:
a first control signal to actuate a starter motor to crank the engine during the start-up state, wherein the starter motor draws electrical energy from a supercapacitive device;
a second control signal to initiate the supply of electrical energy selectively from a battery to the supercapacitive device other than during the start-up state; and
a third control signal to initiate the selectively supply of electrical energy during the run state from the alternator to the supercapacitive device.

According to a seventh aspect of the invention there is provided a method for controlling an automotive engine having a starter motor, an alternator, a start-up state, and a run state, the method including:
actuating the starter motor to crank the engine during the start-up state, wherein the starter motor draws electrical energy from a supercapacitive device;
supplying electrical energy selectively from a battery to the supercapacitive device other than during the start-up state; and
selectively supplying electrical energy during the run state from the alternator to the supercapacitive device.

According to an eight aspect of the invention there is provided an energy supply system for a drive unit having a start-up state, a Stop-Start state, and an electrical load that draws electrical energy during the Stop-Start state, the system including:
a first energy storage system for supplying electrical energy to: a starter unit that cranks the drive unit during the start-up state; and the electrical load during the Stop-Start state; and
a second energy storage system for selectively supplying electrical energy to the first energy storage system other than during the start-up state.

In an embodiment the second energy storage system selectively supplies electrical energy to the electrical load during the Stop-Start state.

In an embodiment the first energy storage system includes at least one supercapacitive module.

According to a ninth aspect of the invention there is provided an energy supply system for a drive unit having a start-up state, a Stop-Start state, and an electrical load that draws electrical energy during the stop/start state, the system including:
a first energy storage system for supplying electrical energy to: a starter unit that cranks the drive unit during the start-up state; and the electrical load during the Stop-Start state; and
a second energy storage system for selectively supplying electrical energy to the electrical load during the Stop-Start state.

In an embodiment the drive unit includes a run state and the energy supply system includes an electrical supply unit for selectively supplying electrical energy to the second energy storage system during the run state.

According to a ninth aspect of the invention there is provided a method of supplying energy to a drive unit having a start-up state, a Stop-Start state, and an electrical load that draws electrical energy during the Stop-Start state, the method including the steps of:
supplying electrical energy from a first energy storage system to: a starter unit that cranks the drive unit during the start-up state; and the electrical load during the Stop-Start state; and
selectively supplying electrical energy from a second energy storage system to the first energy storage device other than during the start-up state.

In an embodiment the method includes the additional step of selectively supplying electrical energy from the second energy storage system to the electrical load during the Stop-Start state.

According to a tenth aspect of the invention there is provided a method of supplying energy to a drive unit having a start-up state, a stop/start state, and an electrical load that draws electrical energy during the Stop-Start state, the method including the steps of:
supplying electrical energy from a first energy storage system to: a starter unit that cranks the drive unit during the start-up state; and the electrical load during the Stop-Start state; and
selectively supplying electrical energy from a second energy storage system to the electrical load during the Stop-Start state.

According to an eleventh aspect of the invention there is provided a mechanical drive system including:
a drive unit for providing drive to a drive-train, the drive unit having a start-up state, a Stop-Start state, and an electrical load that draws electrical energy during the Stop-Start state;
a starter unit for cranking the drive unit during the start-up state;
a first energy storage system for supplying electrical energy to: the starter unit during the start-up state; and the electrical load during the Stop-Start state; and
a second energy storage system for selectively supplying electrical energy to the first energy storage device other than during the start-up state.

In an embodiment the drive unit includes a run state and the energy storage system includes an electrical supply unit for selectively supplying electrical energy to the second energy storage system during the run state.

In an embodiment the mechanical drive system includes an electrical supply unit for selectively supplying electrical energy to the first energy storage system during the run state.

In an embodiment the drive unit is an internal combustion engine and the electrical supply unit is an alternator or a starter-generator that is driven by the engine during the run state.

In an embodiment the first energy storage system includes at least one supercapacitive device and the second energy storage system includes at least one electrochemical storage device.

In an embodiment the first energy storage system includes at least two supercapacitive devices and the second energy storage system includes at least one battery.

In an embodiment the starter unit is a DC starter motor.

In an embodiment the second energy storage system selectively supplies energy to first energy storage system other than in the start-up state.

In an embodiment the second energy storage system selectively supplies energy to the first energy storage system immediately prior to the start-up state.

In an embodiment the second energy storage system selectively supplies energy to the electrical load during the Stop-Start state.

According to a twelfth aspect of the invention there is provided a mechanical drive system including:
a drive unit for providing drive to a drive-train, the drive unit having a start-up state, a Stop-Start state, and an electrical load that draws electrical energy during the Stop-Start state;
a starter unit for cranking the drive unit during the start-up state;
a first energy storage system for supplying electrical energy to: the starter unit during the start-up state; and the electrical load during the Stop-Start state; and
a second energy storage system for selectively supplying electrical energy to the electrical load during the Stop-Start state.

According to a thirteen aspect of the invention there is provided a method of controlling a drive unit having a start-up state, a run state, a Stop-Start state, and an electrical load that draws electrical energy during the Stop-Start state, the method including the steps of:
cranking the drive unit during the start-up state with a starter unit;
supplying electrical energy from a first energy storage system to: the starter unit during the start-up state; and the electrical load during the Stop-Start state; and
selectively supplying electrical energy from a second energy storage system to the first energy storage device other than during the start-up state.

It will be appreciated that in embodiments of the invention the electrical load typically draws electrical energy during both the run state and the stop-start state. During the run state the electrical is supplied by the alternator or starter/generator. In the stop-start state that energy is supplied selectively by the first and second storage systems.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments. The specific definition or description of a feature or combination of features as attributed to an embodiment is not to be interpreted as meaning that the feature or combination of features is cannot be found in another different embodiment, or that the feature of combination of features are not able to be combined with other features attributed to other embodiments.

Moreover, the features included within a specific described embodiment are able to be used in other described embodiments unless such a combination would be understood as being mutual excluded by the skilled addressee.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 is a perspective view of a car including an automotive drive according to an embodiment of the invention;

FIG. 2 is a schematic diagram of the automotive drive use in the car of FIG. 1;

FIG. 3 is a circuit diagram for a first current limiting circuit for use in the automotive drive of FIG. 2;

FIG. 4 is an example of the charging current provided to the supercapacitive device used in the automotive drive of FIG. 2;

FIG. 5 is a circuit diagram for a second current limiting circuit for use in the automotive drive of FIG. 2;

FIG. 6 is a schematic representation of an engine management system used in the car of FIG. 1 and for controlling the implementation of the automotive drive of FIG. 2;

FIG. 7 is a flowchart illustrating a method of providing automotive drive of the embodiment implemented with the engine management system of FIG. 6;

FIG. 8 is a flowchart illustrating a specific method of stop-start functionality as used in an embodiment of the invention;

FIG. 9 is a schematic representation of the circuit of FIG. 5 having additional components;

FIG. 10 is a schematic representation of a control system for an automotive drive;

FIG. 11 illustrates selected voltage and current waveforms for a starting operation of an SUV having a prior art control system;

FIG. 12 illustrates selected voltage and current waveforms for a starting operation of an SUV having the control system of FIG. 10;

FIG. 13 is schematic representation of a further control system for an automotive drive;

FIGS. 14 to 17 illustrate energy flows between components in a drive train making using of the control system of FIG. 13; and

FIG. 18 is a circuit diagram of one specific implementation for the DC to DC converter circuit and switch used in the control system of FIG. 10.

### DETAILED DESCRIPTION

The following description should be read in light of the disclosure in: Australian provisional patent application 2013902404 filed 28 Jun. 2013 and entitled “An energy supply system for and a method of supplying energy to a drive unit”; and Australian provisional patent application 2013902405 filed 28 Jun. 2013 and entitled “A current limit circuit for a supercapacitive device”. The disclosure of both these applications, it their entirety, is incorporated herein by way of cross reference.

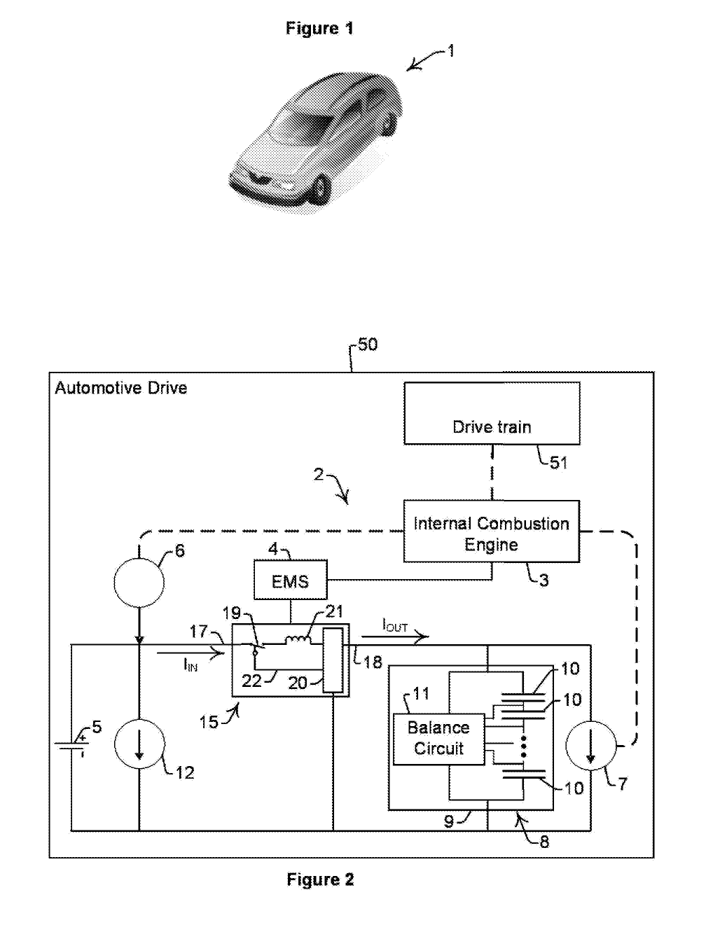

Referring to FIG. 1 there is illustrated an automotive vehicle in the form of a car 1 that has an automotive drive 2 as shown in FIG. 2. Drive 2 includes stop/start functionality as will be described in more detail below. In FIG. 2 the connections represented by solid lines and broken lines respectively indicate electrical and mechanical connections between the associated components.

System 2 includes an internal combustion engine 3 and an electronic engine management system (EMS) 4 for controlling and monitoring many aspects of the operation of engine 3. This control includes, for example, fuelling, valve timing, and temperature management of engine 3. The monitoring includes fluid levels and temperatures, voltage levels, and others. It will be appreciated by those skilled in the art that additional or other aspects of the operation of engine 3 are able to be included within the scope of EMS 4.

System 2 includes a 12 Volt 30 Amp·hour lead acid battery 5 for providing an energy store within car 1. This energy store is selectively drawn upon, as will be described in more detail below. In other embodiments different batteries are used. For typical mass production automotive applications the rating of the battery will usually fall within the range of about 20 Amp·hours to 60 Amp·hours. In specialist applications the battery is rated outside this range. Moreover, in further embodiments use is made of a battery providing a voltage other than 12 Volts. Furthermore, in some embodiments the battery includes a plurality of interconnected batteries.

An alternator 6 is mechanically driven by engine 3 (when engine 3 is running) for providing up to about 14 Volts of electrical potential that is used, as required, for recharging battery 5. A DC starter motor 7 is selectively actuated to crank engine 3 during a starting sequence for that engine. During this starting sequence (which is part of the stop/start operation) motor 7 will draw a cranking current and draw several kW at a peak current and more than 1 kW for at least about one second. When the starting operation is the first start after engine 3 has experienced a prolonged period of inactivity, motor 7 is usually required to sustain the cranking for longer than would be the case for a starting sequence that occurred during the stop/start operation.

In other embodiments, alternator 6 and starter motor 7 are substituted by a single starter-generator unit (not shown).

System 2 includes a supercapacitive device 8 that is electrically connected across motor 7 for supplying current to that motor during the starting sequence. That is, device 8 provides current (referred to as the cranking current) to a load that is comprised of motor 7. In this embodiment, device 8 includes a single prismatic sealed housing 9 having dimensions of about 220 mm×145 mm×75 mm that contains six substantially identical individual supercapacitive cells 10 which are connected in series to provide a total capacitance of 150 Farads and an equivalent series resistance (ESR) of 5 mOhms. Also contained within housing 9 is an active balance circuit 11 for maintaining substantially the same voltage across each of cells 10 to protect against overvoltage across the cells 10. In other embodiments circuit 11 is a passive balance circuit.

In other embodiments the supercapacitive device has a different capacitance and/or different form factor and/or dimensions from the supercapacitive device referred to above. By way of example, a further supercapacitive device (not shown) includes a like housing to device 8, but through the use of higher surface area carbons on the electrodes, provides a capacitance of 250 Farads and an ESR of 2 mOhms.

The form factor for housing 9 has been selected to optimise packing within an existing space within or near to an engine bay of a car or other automobile in which the embodiment is being deployed. In one such embodiment the prismatic supercapactive device 8 is mounted adjacent to and alongside battery 5. In another embodiment, device 8 is disposed within a cavity elsewhere in the engine bay. In further embodiments, device 8 is disposed in the engine bay of car 1 and placed closely adjacent to motor 7. It will be appreciated by those skilled in the art that other locations are also available depending upon the design optimisation that is being sought.

The above mentioned supercapacitive device 8 has a generally prismatic housing 9 in which is disposed the stacked cells 10. Each of these cells includes at least two stacked generally rectangular aluminium sheet electrodes having respective carbon coatings that are opposed. It has been found that the use of rectangular sheet electrodes, and the consequent prismatic form of housing 9, allows for better packing density and more convenient placement of device 8. However, in other embodiments, particularly for specialist applications, use is made of differently shaped devices 8. For example, in some embodiments, device 8 has an irregular shape to fit within an available cavity in an engine bay, or around another component in that engine bay.

In further embodiments, circuit 11 is disposed externally to housing 9. Moreover, in still further embodiments, cells 10 are individually housed and electrically connected to circuit 11 which is separately housed also.

It will be appreciated by those skilled in the art that in other embodiments cells 10 are placed in parallel and/or series to provide the required capacitance, form factor, ESR and/or voltage required for the specific application. Moreover, in further embodiments, a different number of cells are used.

Device 8 includes at least one supercapacitive device to provide a compact store of energy that is able to be quickly discharged to power motor 7—that is, to easily supply the cranking current to motor 7—and easily charged by alternator 6 (and less frequently by battery 5). A suitable supercapacitive device includes one or more high capacitance low ESR supercapacitors. Preferentially, the supercapacitor is a carbon double layer supercapacitor formed from a plurality of stacked aluminium sheets with intermediate separators and electrolyte, where the aluminium sheets have respective carbon layers at which the double layer capacitor is formed.

System 2 also includes an electrical load 12, which is used to collectively represent, with the exception of motor 7, all the electrical loads within car 1 that draw electrical power whether or not car 1 is moving, and whether or not engine 3 is running. This electrical load 12 is also referred to as the “hotel load”. By way of example, load 12 includes one or more of:
The power assistance for the brakes and steering systems for car 1.
The headlights, parking lights, tail lights, blinkers, internal lights and other lights or lighting systems used by car 1.
The sound system, radio or other in car entertainment systems that are installed and operating within car 1.
Any GPS or other navigation system.
EMS 4.

In other cars different or additional electrical loads will be included in the hotel load. It will also be appreciated that, at different times, load 12 will draw considerably different currents depending upon the nature and manner of use of the constituent loads.

A current limit circuit 15 is provided for supercapacitive device 8 in system 2. Circuit 15 includes an input, in the form of a terminal 17, for drawing a load current I_{IN} from at least one of battery 5 and alternator 6. During the normal stop/start operation, current limit circuit 15 is only active when alternator 6 is operating—which also corresponds to when engine 3 is operating normally—and, as such, I_{IN} is only drawn from alternator 6.

Prior to a starting sequence that follows a long period of inactivity by engine 3—that is, following from engine 3 having been turned off by the operator of car 1 and left inactive—circuit 15 is active to selectively allow battery 5 to provide I_{IN}. It will be appreciated that if EMS 4 determines there is sufficient charge retained by device 8 that circuit 15 will remain disabled and, consequently, I_{IN} prior to this starting sequence will be zero.

An output, in the form of a terminal 18, supplies a charging current I_{OUT} to supercapacitive device 8. A switching device 19 is disposed between terminals 17 and 18 and is responsive to a first and a second control signal for respectively progressing toward a high impedance state and a low impedance state to prevent and allow the drawing of I_{IN}.

A sensor device 20 provides the first control signal in response to either or both of: I_{OUT} being greater than a predetermined upper threshold; and the voltage at the output 18 being above a predetermined voltage. In this embodiment the predetermined voltage is the voltage at input 17. In other embodiments, device 20 also provides the first signal in response to the voltage at output 18 being greater than or equal to the maximum rated voltage for device 8. In this embodiment the maximum rated voltage is 14 Volts. In other embodiments use is made of different supercapacitive devices having different maximum rated voltages. Typical maximum rated voltages for supercapacitive devices used in a 12 Volt automotive system will often fall within the range of 14 to 16 Volts, although many other values are available.

In some embodiments, EMS 4 is responsive to the temperature of the supercapacitor (or a measurement indicative of the temperature of the supercapacitor) for dynamically adjusting the threshold at which the first signal is provided. It will be appreciated that as the temperature increases the voltage threshold at which the first signal is generated will decrease. This provides greater protection to the supercapacitor during warmer operating conditions, while allowing fuller use of the available capacitance during colder conditions. This, in turns, contributes to a longer operational lifetime for supercapacitive device 8.

Device 20 also provides the second control signal in response to I_{OUT} falling below a predetermined lower threshold. It will be appreciated that both the first control signal and the second control signal are provided by device 20 to device 19 via a common conductive connector 22. In other embodiments separate connectors are used for each of the first and second control signals.

Circuit 15 also includes an inductive device, in the form of a high flux core inductor 21, through which I_{IN} flows downstream of switch 19. More particularly, inductor 21 is disposed directly between switch 19 and the sensor device 20.

It will be appreciated that EMS 4 controls circuit 15 to be in either an ON state or an OFF state. When in the ON state, circuit 15 operates as set out above and provides a current limiting operation. In the OFF state, circuit 15 does not operate and isolates the circuits including the respective energy storage devices. That is, it isolates battery 5 and device 8. It will also be appreciated that, in the OFF state, both I_{IN} and I_{OUT} are effectively zero.

System 2 includes three states, these being:
State 1: where EMS 4 controls engine 3 to run normally.
State 2: which commences when EMS 4 automatically turns off engine 3 in response to car 1 slowing down or halting.
State 3: which is preceded by State 2 and succeeded by State 1. This includes a starting sequence of engine 3 being initiated by EMS 4.

Engine 3 includes an ignition switch (not shown) for allowing an operator of car 1 to selectively actuate engine 3. When the ignition is active EMS 4 controls engine 3 to be in one of the three states mentioned above. When the ignition is not active—that is, at those times when the operator intends for the engine to be off and the car not in use—EMS 4 is substantially inactive and none of the above three states exist. In other embodiments EMS 4 provides for additional states to the three states mentioned above.

Returning to the instances when the ignition of car 1 is active—that is, that one of the above three states persists—the state of circuit 15 is as follows:

| State of System 1 | State of Circuit 15 |
|---|---|
| State 1 | ON |
| State 2 | OFF |
| State 3 | OFF |

During State 1, when engine 3 is being controlled by EMS 4 to run normally, alternator 6 generates a voltage of about 14 Volts and supplies a current that is used conventionally to charge battery 5 progressively. That is, terminal 17 is maintained at about 14 Volts.

EMS 4 also maintains circuit 15 in the ON state so that device 8 is also charged to about 14 Volts by alternator 6, although with the predetermined upper threshold for I_{OUY} being 75 Amps and the lower threshold being 60 Amps. As circuit 15 is only ON when alternator 6 is able to supply a charge current, battery 5 will not be called upon to charge device 8 during the usual stop/start operation of EMS 4. In this embodiment, the only time battery 5 will be relied upon to provide charge current to device 8 is when the ignition changes to an active state from an inactive state and the voltage at terminal 18 is assessed by EMS 4 as being too low to achieve a successful cranking of engine 3. That is, I_{IN} is only drawn from battery 5 following from typically a prolonged period of inactivity for car 1 directed by the operator of the car, and not following from an automated State 2 that was dictated by EMS 4.

In other embodiments the upper and lower threshold are different to the specific values mentioned above. Moreover, in some embodiments one or both of the upper and lower thresholds are dynamically varied by EMS 4 to in response to one or more selected operating conditions of the components used within system 1.

As device 8 has very low ESR and a very high capacitance, circuit 15 is operable to ensure device 8 does not draw excessive current from alternator 6 or, in the limited circumstances mentioned above, from battery 5.

A failure to provide the current limiting described above will result in damage to either or both of battery 5 and/or alternator 6. As an example, if battery 5 provides 12 Volts and has an internal impedance of 6 mΩ, and the device 8 has an ESR, of 4 mΩ and is fully discharged—that is, if terminal 18 is at zero Volts—then, without the operation of circuit 15, device 8 would attempt to draw 1,200 Amps. The maximum current limit for I_{OUT} in the above embodiment is the upper threshold—that is, 75 Amps. Accordingly, the maximum current that alternator 6 or battery 5 will have to provide to device 8 is 75 Amps regardless of the potential difference between terminal 17 and terminal 18. However, in other embodiments different upper thresholds are used based upon the rating of the battery and/or the alternator. Typically, however, for passenger cars, the upper threshold is within the range of 50 Amps to 100 Amps. Moreover, in different embodiments the lower thresholds are set at other than 60 Amps.

When EMS 4 detects a sufficient slowing of car 1 or the halting of car 1 it enters State 2; which is to say that it initiates the stop/start functionality of system 2. This involves EMS 4 automatically turning off engine 3. With engine 3 turned off, alternator 6 no longer supplies any current to charge battery 5 or device 8. Moreover, in State 2, EMS 4 maintains circuit 15 in the OFF state so that device 8 is isolated from battery 5. At the instant circuit 15 is progressed from the ON state (when system 2 is in State 1) to the OFF state (when system 2 progresses to State 2) device 8 will be at the voltage it was charged to by alternator 6. In the present embodiment this voltage is about 14 Volts on the assumption that system 2 had been in State 1 (that is, engine 3 had been running) for sufficient time for device 8 to be fully charged to that voltage.

It will be appreciated that in the present embodiment that the time taken to fully charge device 8 from a totally discharged state will be about 30 seconds. However, it is usual that device 8 will maintain some level of charge and, as such, the more typical time to progress to the fully charged state is about 10 seconds. In practical terms, during normal use of car 1, it is usual for device 8 to be fully charged at the commencement of State 2.

When alternator 6 is turned off (due to engine 3 being turned off) the voltage provided by battery 5—that is, the voltage at terminal 17—will drop from about 14 Volts to about 12 to 12.5 Volts (depending upon the type and state of charge of battery 5). As EMS 4 has progressed circuit 15 to the OFF state, device 8 is isolated from terminal 17 and cannot discharge back into battery 5.

Circuit 11 is an active design to maintain a substantially equal voltage across each of cells 10 and to minimise leakage current in device 8. This also acts advantageously in the present embodiment to slow the discharge of cells 10 during State 2. In other embodiments use is made of a passive balance circuit, or of an active balance circuit that scavenges the current bled from any overvoltage cell for supply to one or more of the cells 10.

The above described State 2 is typically initiated when car 1 halts at an intersection or traffic lights. Accordingly, EMS 4 remains responsive to inputs from the driver of car 1 that may indicate there is a desire to move from being halted. Typical inputs to EMS 4 to indicate such a desire include the operator pressing on the accelerator pedal, releasing the brakes or, for manual cars, depressing the clutch pedal. The input, or combinations of inputs, used by EMS 4 to assess this desire of the operator vary between cars. Once the desire has been assessed, in whatever way, EMS 4 then progresses system 2 to State 3. Particularly, EMS 4 continues to maintain circuit 15 in the OFF state—to maintain the electrical isolation of terminals 17 and 18—whilst initiating a starting sequence for engine 3. This involves, amongst other things, actuating motor 7 to crank engine 3. The cranking current drawn by motor 7 is supplied solely by device 8 for, as mentioned above, terminals 17 and 18 remain electrically isolated from each other.

The low ESR and high capacitance of device 8 delivers the required power to motor 7 for the required duration to allow the staring of engine 3. For device 8, where the capacitance is 150 F and the ESR 5 mΩ, it discharges from 14 Volts to 10.5 Volts after supplying 300 Amps for 1 second, which is usually sufficient to start engine 3 during a starting sequence that is part of the stop/start operation controlled by EMS 4. Where use is made of the earlier referred to supercapacitive device having a capacitance of 230 Farads and an ESR 3 mΩ, it discharges from 14 Volts to 11.8 Volts.

Once EMS 4 assesses that engine 3 has started—and as a result alternator 6 is operable to supply current—it returns system 2 to State 1. Accordingly, circuit 15 is toggled to the ON state and alternator 6 supplies I_{IN} once again in addition to providing any charging current to battery 5. Typically the charging current to battery 5 at this point would be low.

The above architecture/topology decouples battery 5 from providing starting current to motor 7. This allows battery 5 to be saved from premature aging that would otherwise result from the increased frequency of discharges required due to the increased number of starts of engine 3.

It should also be noted that car 1 includes an ignition that is either OFF or ON. When the ignition is ON, EMS 4 controls system 2 as described above. However, when the ignition is OFF, EMS 4 is substantially inactive and circuit 15 is in the OFF state to minimise current drain from battery 5 due to any leakage currents in device 8. Once the driver activates car 1 after a prolonged stop—for example, by actuating the central locking from a key fob—EMS 4 progresses circuit 15 to the ON state so that device 8 is able to be charged. While it is possible to fully charge device 8 in this way, it is not usually necessary to do so. Rather, device 8 is charged to a starting voltage deemed sufficient to allow for a subsequent successful starting sequence for engine 3. This starting voltage is, in some embodiments, fixed at a minimum of 10.5 Volts. However, in other embodiments, the voltage varies depending upon one or more predetermined factors. Examples of such factors include; the type of engine (petrol, diesel); the starting characteristics of the engine; the capacitance of device 8; the ESR of device 8; the ambient temperature; the temperature of the engine; the time since the engine last operated; the state of charge of the battery; and other factors relevant to the starting of the engine.

In other embodiments, EMS 4 maintains circuit 15 in the ON state when the ignition is OFF so that device 8 remains charged and ready to start car 1 for the first start after a period of being inactive. For the specific device 8 used in the above described embodiments, where use is made of an active balance system, the leakage current is about 10 mA. Accordingly, battery 5 (which in this embodiment is rated at 30 Amp·hour) only loses 0.8% of its charge in maintaining a full charge on device 8 for 24 hours. In still further embodiments, EMS 4 maintains circuit 15 in the ON state when the ignition is OFF, although only for a predetermined interval. This allows device 8 to remain charged during that predetermined interval and to be immediately ready to start car 1 for the first start after a period of being inactive (where that period is less than the predetermined interval). In circumstances where the period is greater than the predetermined interval, there may be a short delay before engine 3 is started to account for the time taken to sufficiently charge device 8 from battery 5. This provides for immediate starting for a car that is used regularly, and yet safeguards against premature discharge of battery 5. In some embodiments the predetermined interval is 24 hours. However, in other embodiments it is less than or greater than twenty four hours.

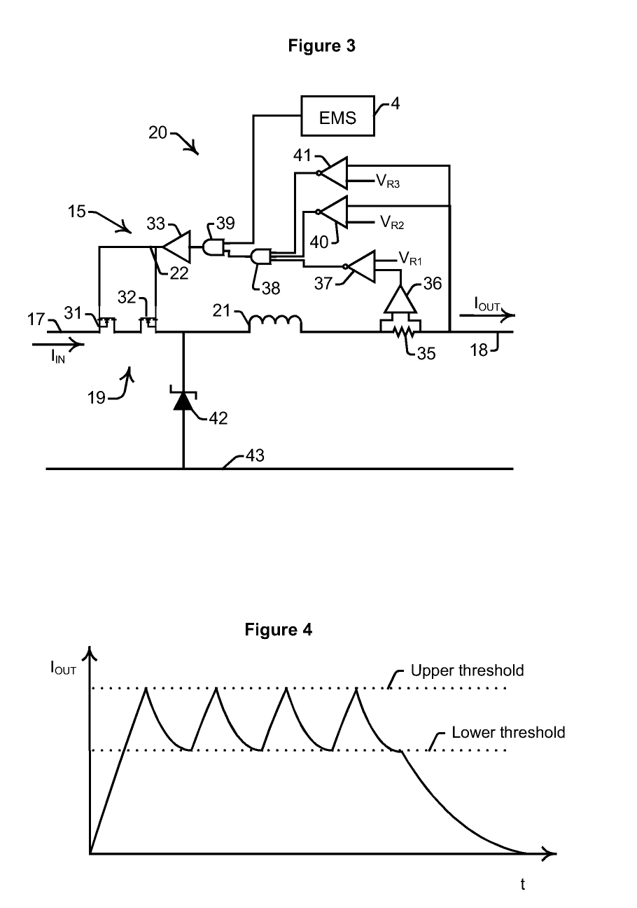

Reference is now made to a more detailed schematic diagram of circuit 15 in FIG. 3, where corresponding features are denoted by corresponding reference numerals. It will be appreciated that in other embodiments different circuits are used to provide the required functionality and that the specific circuit illustrated is exemplary only. More particularly, switch 19 is implemented with two back-to-back NFETs 31 and 32 that have gates which are commonly connected to the output of a gate drive circuit 33. This circuit, together with the other associated logic circuits, is part of sensor device 20. It will be appreciated that the NFETs include body diodes and, as such, are placed in a back-to-back configuration to prevent: device 8 from discharging back into battery 5 when the voltage at terminal 18 is greater than the voltage at terminal 17; and battery 5 discharging into device 8 when the voltage at terminal 17 is greater than the voltage at terminal 18 when switch 19 is OFF.

In addition to circuit 33, device 20 includes a high accuracy and low value current sensing resistor 35, an operational amplifier 36 connected across resistor 35 and a comparator 37 with hysteresis for changing state when the output of amplifier 36 exceeds a first voltage reference V_{R1}. The output of comparator 37 is connected to one of the three inputs of an AND gate 38, while the output of gate 38 is connected to one of the two inputs of an AND gate 39. The output of gate 39 is connected to the input of circuit 33.

It will be appreciated that EMS 4, to maintain circuit 15 in the ON state, holds the relevant input of gate 39 high. Accordingly, in the ON state, if I_{ouT} exceeds a predetermined upper threshold—which, in this embodiment, is 75 Amps—the gates of NFETs 31 and 32 will go low and, as a result, the FETs will assume a high impedance state. That is, switch 19 will move from a closed state in which I_{IN} flows into circuit 15 from terminal 17 to an open state in which I_{IN} falls to zero. When the latter occurs, I_{OUT} will fall progressively due to the operation of inductor 21 and Schottky diode 42 until such time as the output voltage of amplifier 36 falls below (V_{R1}—hysteresis voltage of comparator 37). In response, the output of comparator 37 will go high and, consequentially, the output of amplifier 33 will go high to progress NFETs 31 and 32 to a low impedance state. At this point I_{IN} will again flow. The result is, for those times when device 8 draws significant current from battery 5 and/or alternator 6, I_{OUT} will follow a pseudo-sawtooth pattern between the upper and lower threshold. An example of IOUT during the charging of device 8 by alternator 6 is illustrated in FIG. 4. Whilst only a small number of cycles of the current limiting function are illustrated in FIG. 4 before I_{OUT} decays to zero as device 8 approaches a fully charged state, it will be appreciated that a different number of such cycles will occur depending upon the voltage initially across device 8, the voltage provided by alternator 6, and the capacitance of device 8.

It will also be appreciated that circuit 15 allows substantially unimpeded flow of I_{IN} and I_{OUT} for low values of those currents. For the current limiting provided by circuit 15 only operates when the voltage at terminal 17 is sufficiently greater than that at terminal 18 to cause I_{OUT} to reach 75 Amps.

Circuit 15 also includes other protection functions in addition to the current limiting function described above. A first example of such a protection is provided by a comparator 40, which compares the voltage at terminal 18 with a reference voltage V_{R2}. In this embodiment V_{R2} is set at 14 Volts, and the output of comparator 40 goes low when the voltage at terminal 18 exceeds V_{R2} to ensure that NFETs 31 and 32 both progress to a high impedance state if the voltage provided by battery 5 (or more likely alternator 6) exceeds 14 Volts. This protects device 8 from an overvoltage condition. In other embodiments V_{R2} is set at other than 14 Volts. For example, some forms of supercapacitive devices are very sensitive to overvoltage conditions. Circuit 15 is able to be designed to accommodate this sensitivity and to provide protection for the supercapacitive device to prolong its operational lifetime and contribute to the efficient and effective operation of system 1.

A further protection function is provided by comparator 41, which compares a further reference voltage V_{R3} with the voltage at terminal 18. In this instance, V_{R3} is the voltage at terminal 17. Should the voltage at terminal 18 exceed V_{R3} the output of comparator 41 goes low to ensure NFETs 31 and 32 are in the high impedance state to prevent discharging of device 8 into battery 5.

Diode 42 provides a return current path for inductor 21 when switch 19 is in the high impedance state.

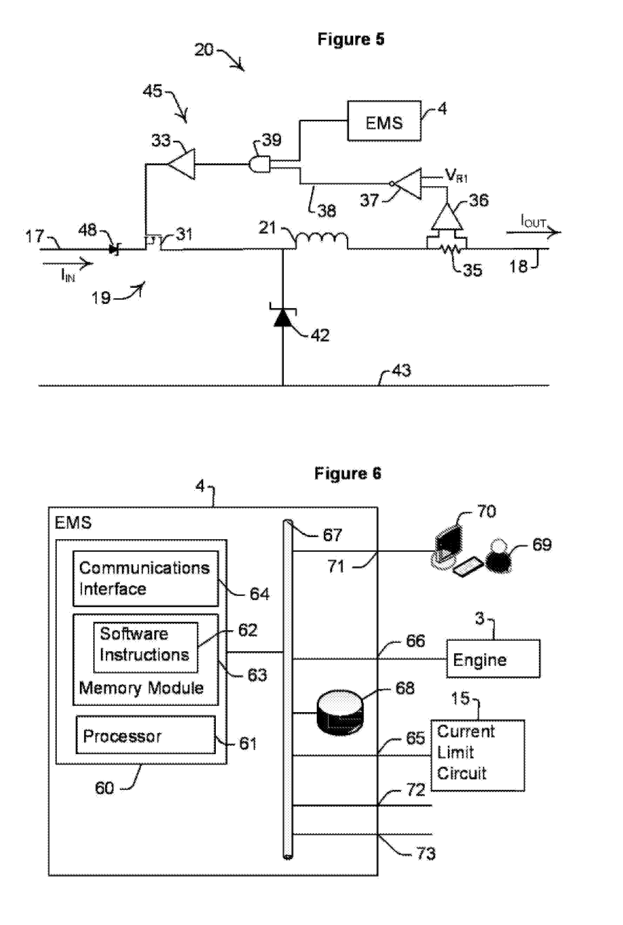

Reference is now made to FIG. 5, where corresponding features are denoted by corresponding reference numerals. In this Figure there is schematically illustrated another current limit circuit 45 that is able to be used in system 2 instead of circuit 15. It will be understood that circuit 45 operates broadly similarly to circuit 15, although with less of the additional functionality. More particularly, the design considerations for circuit 45 are more heavily weighted toward low cost and minimal components, whereas the design considerations for circuit 15 are more heavily weighted toward high levels of additional functionality. It will be appreciated by the skilled addressee, with the benefit of the teaching herein, that other circuits are available to allow the realisation of different design considerations.

Circuit 45 includes a diode 48 to prevent a reverse flow of current from device 8 to battery 5. That is, to ensure that I_{IN} cannot be negative—or, in other words, to ensure that device 8 cannot discharge back into battery 5. It is also assumed that the voltage at terminal 17 will not subject device 8 to an overvoltage condition. In other embodiments, where the risk of such a condition is more likely, additional protection is provided to protect device 8.

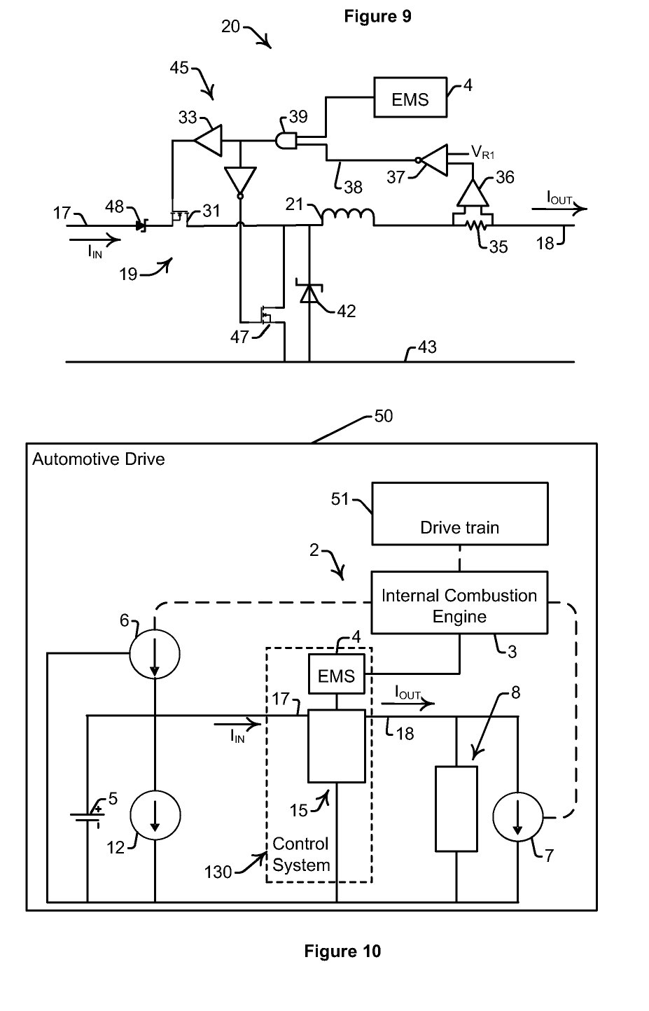

In other embodiments of circuits 15 and 45 use is made of a switch (such as a FET) in parallel with diode 42. By way of example there is illustrated in FIG. 9 a further version of circuit 45 with an additional NFET 47. This NFET is turned ON when NFET 31 (which is a form of switch 19 from FIG. 1) is turned OFF, and turned OFF when switch 19 is turned ON. The gate drive logic to control this NFET is a “break before make” logic. That is, NFET 47 and switch 19 are never both ON simultaneously, not even for extremely short periods such as nanoseconds. If switch 19 is ON and NFET 47 is OFF, then switch 19 must be turned OFF before NFET 47 is turned ON. Conversely, if switch 19 is OFF and NFET 47 is ON, then NFET 47 must be turned OFF before switch 19 is turned ON. NFET 47 improves the efficiency of the circuit since the power loss across NFET 47 will be much less than the power loss across diode 42. The body diode of the NFET is able to conduct current during the short “break” time when both the NFET and switch 19 are OFF. Diode 42 is also able to be included in parallel with NFET 47 to conduct this current more efficiently during the “break” time, or to protect NFET 47 if the power dissipated by the diode during this time is excessive. This is done to also protect the NFET 47 from damage.

The inclusion of NFET 47, as described above, improves the efficiency of the associated circuit, since the power loss across NFET 47 is much less than the power loss across diode 42. The body diode of NFET 47 conducts current during the short “break” time when both NFET 47 and switch 19 are both OFF. Diode 42 is in parallel with NFET 47 to conduct the current more efficiently during the “break” time, and to protect NFET 47 if the power dissipated by the body diode during this time is excessive.

A circuit similar to circuit 45 is disclosed in FIG. 3 of Australian patent application 2013902405, and the description of that latter circuit and its operation, including FIG. 4 in Australian patent application 2013902405, are expressly incorporated herein by way of cross reference.

In other embodiments a current limit circuit other than circuit 15 or circuit 45 is used. In still further embodiments, the current limit circuit operates on principles other than those used by circuit 15 or circuit 45. It will also be appreciated by those skilled in the art that different hardware configurations are possible to achieve the same functions described above. For example, in some embodiments use is made of a micro-controller or similar hardware to provide the required logic functions.

The above automotive architecture/topology provides for an automotive drive for car 1. That is, system 2 is part of an automotive drive 50 and includes, as shown in FIG. 2, a drive unit in the form of engine 3 for providing drive to a drive train 51. In this embodiment, drive train 50 is incorporated into car 1 and is mechanically connected to engine 3 for transferring drive from engine 3 to the rear wheels of car 1. Drive train 50 includes a transmission (not shown), drive shafts (not shown), a differential (not shown), axles (not shown) and the rear wheels of car 1. In other embodiments additional or other mechanical components and connections are used to allow the drive to be transferred. In some electric and hybrid electric vehicles there are electrical and/or mechanical connections between the various components in the drive train.

Engine 3 has a start-up state—that is, the state that occurs during a starting sequence for engine 3—and a run state—that is, the state that occurs when engine 3 is on and operating normally. A starter unit, in the form of motor 7, cranks the drive unit during the start-up state, and a first energy storage device, in the form of device 8, supplies electrical energy to motor 7 during the start-up state. A second energy storage device, in the form of battery 5, supplies electrical energy selectively to device 8 other than during the start-up state, and an electrical supply unit, in the form of alternator 6, selectively supplies electrical energy during the run state to device 8.

It will be appreciated that alternator 6 selectively supplies electrical energy during the run state to battery 5, and battery 5, due to the operation of circuit 15, selectively supplies electrical energy to device 8 prior to the start-up state.

In other embodiments, the starter unit and the electrical supply unit take the form of a single starter-generator for engine 3.

Engine 3 also includes a stop state where it is not providing drive to the drive train 51, and the automotive drive 50 includes a stop/start controller that is integrated into EMS 4 for selectively progressing engine 3 between the three available states. In this embodiment, EMS 4 progresses engine 3 from the run state to the stop state; from the stop state to the start-up state; and from the start-up state to the run state. In other embodiments additional states are utilised.

It will be appreciated that the hotel load 12 for car 1 draws current from alternator 6 during the run state, and from battery 5 during the stop state and the start-up state. Accordingly, battery 5 is relieved of the dual role of having to simultaneously supply current to the hotel load 12 and the motor 7 and device 8 during the start-up state (which is high current demand period). This significantly reduces the peak current load on battery 5 and also reduces the extent of the discharge experienced by battery 5. Both these factors contribute to an increased operational lifetime for battery 5.

It will be appreciated that EMS 4 is used in this embodiment to provide the required control for system 2. This takes advantage of the existing hardware and software provided by EMS 4. That software is modified (typically added to) to allow the implementation of system 2 in accordance with the description of the implementation as provided in this specification. However, in other embodiments a controller separate from EMS 4 is used to provide all or part of the implementation of system 2. An exemplary illustration is provided in FIG. 6 of EMS 4, and includes a processing unit 60 having a microprocessor (referred to as processor 61) for executing software instructions 62 that are stored in memory module 62 (EEPROM, Flash memory, ROM or RAM) and accessed as required by processor 61.

Unit 60 also includes a communications interface 64 for enabling communication with external devices and components such as circuit 15, engine 3 and the like via respective communication ports 65 and 66. Whilst interface 64 enables the communications through coding, decoding and other operations, all the signals are transmitted via an internal communications bus 67 within EMS 4.

EMS 4 also includes non-volatile memory in the form of solid state memory module 68 for containing additional software instructions that are, when required, loaded into module 62 for subsequent execution by processor 61. Processor 61 also stores data in module 68 about one or more aspects of the control or performance of car 1 and the associated systems. This data is able to be later downloaded or otherwise inspected by service personnel 69 making use of a computer 70 that is connected to EMS 4 via a port 71.

EMS 4 also includes other ports for allowing communication to be established with other devices such one or more of the individual loads making up the hotel loads for car 1, such as the HVAC system in car 1, the entertainment system within car 1, or the like. In FIG. 6 there are illustrated two free ports 72 and 73. However, in other embodiments there are no additional ports, whilst in further embodiments there are many additional ports.

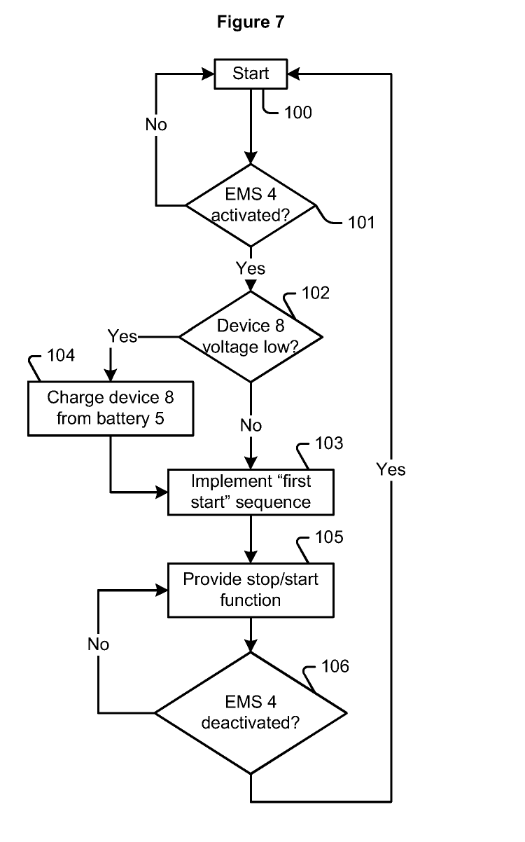

Reference is now made to FIG. 7 where there is illustrated a flow chart for the operation of EMS 4 in providing the stop/start functionality of system 2 and automotive drive 50. More particularly, when car 1 is not in use there is a very low level of operation occurring. In this embodiment, EMS 4 is inactive when the car 1 is not in use, save for being receptive to a disarm signal from a key fob for car 1 that is typically carried by the operator of the car. In this state, EMS 4 is maintained at step 100 as shown in FIG. 7. Upon that disarm signal being received, EMS 4 is activated at step 101 and it initiates various actions. These include the unlocking of one or more of the doors of car 1, the disarming of the immobiliser system and alarm system, and the illumination of a number of interior lights in car 1. Additionally, at step 102, EMS 4 is responsive to the voltage at terminal 18 to determine if there is a need to provide additional charge to device 8 prior to commencing a first start sequence for engine 3 at step 103. If the voltage is below a predetermined threshold—which in this embodiment is 10.5 Volts—then EMS 4 progresses to step 104 and activates circuit 15 to allow battery 5 to supply I_{IN} until such time as the voltage at terminal 18 has risen to the predetermined threshold. The operation of circuit 15 is to selectively limit I_{IN} such that it will not exceed the upper threshold of 75 Amps, but to ensure that nor will it drop below the lower threshold of 60 Amps until the voltage at device 8 approaches that of terminal 17. When the current does fall below the lower threshold switch 19 is maintained in a low impedance state and the current is allowed to decay as the voltage at device 8 substantially equalises with the voltage at terminal 17. If device 8 reaches its maximum voltage then circuit 5 is disabled and the current flow from battery 5 or alternator 6 into device 8 is halted. As mentioned above, device 8 need not necessarily be charged fully at this step.

With device 8 being deemed by EMS 4 to be sufficiently charged—which should only take a few seconds to occur even if the voltage at terminal 18 is relatively low—the first start sequence is able to be initiated at step 103 in the usual way by the operator of the car inserting the car key (not shown) into the ignition of car 1 (not shown) and twisting to the appropriate position. During this start-up sequence, EMS 4 controls engine 3 to implement the start-up sequence. In other embodiments use is made of a proximity card rather than a key and/or a push button on the dash to actuate the start-up sequence.

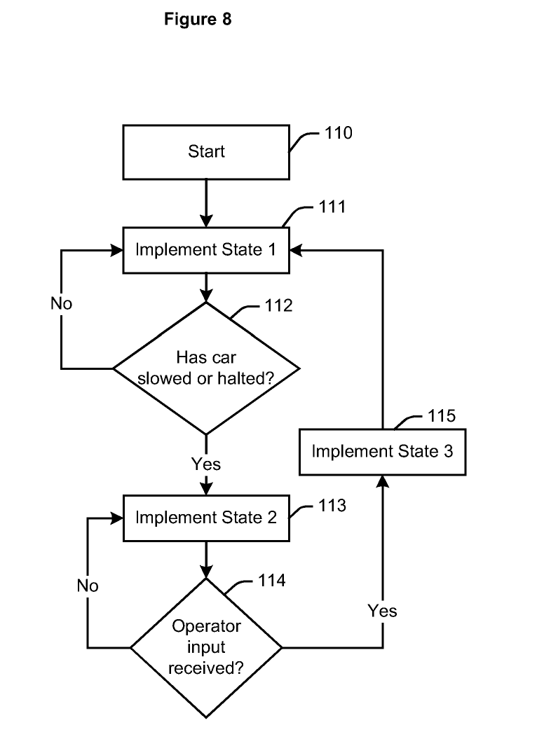

With engine 3 having progressed through the start-up sequence and now normally operating, EMS 4 controls engine 3 at step 105 to be in one of the three states mentioned above, State 1, State 2, or State 3. That is, EMS 4 controls the implementation of the stop/start functionality for car 1. This will be described below with reference to FIG. 8.

Once the operator has finished using car 1 the key is used to turn the ignition off. This occurs typically by twisting the key to the off position and removing it from the ignition switch. EMS 4 is responsive to this at step 106 for performing a number of final operations and then progressing to a deactivated mode by returning to step 100.

Reference is now made to FIG. 8 where there is illustrated schematically a more specific method for providing the stop-start functionality referred more generally to at step 105 in FIG. 7. More specifically, following from the initial start sequence EMS 4 initiates the stop/start function at step 105 in FIG. 7, which initially corresponds to step 110 in FIG. 8. That is, EMS 4 will progress to step 111 and maintain engine 3 in State 1 so that car 1 is able to operate and drive normally.

During State 1 alternator 6 provides current to charge battery 5, should that be required. Moreover, circuit 15 will be active and, as such, alternator is able to supply current to device 8 so that it is maintained at the alternator voltage, or the maximum voltage for device 8, whichever is the lesser. Circuit 15 will ensure that I_{IN} will be limited to a maximum value.

During the maintenance of State 1 EMS 4 progresses to step 112 and continuously monitors one or more characteristics of engine 3 and/or car 1 to ascertain if car 1 has sufficiently slowed or halted. If the monitored parameters indicate that this is not the case, EMS 4 returns to step 110 to maintain State 1. If, however, the assessment is that the car has slowed sufficiently or halted, EMS 4 progresses to step 113 where it implements State 2. That is, in State 2 engine 3 is turned off to conserve fuel and reduce pollution, the hotel loads are supplied by battery 5, and EMS 4 progresses to step 114 to ascertain if the operator has provided one of one or more predetermined inputs that are taken as an indication that there is now a desire for car 1 to resume the journey. If no such input is received, EMS 4 returns to step 113 and maintains State 2. That is, engine 3 remains turned off, and battery 5 continues to supply the hotel load 12. Moreover, in State 2, circuit 15 is deactivated and battery 5 is isolated or electrically decoupled from device 8.

EMS 4 will typically periodically assess for inputs from the operator at intervals of less than one second. That is, EMS 4 progresses from step 113 to step 114 in less than one second.

Once the required input or inputs are assessed as having being provided by the operator, EMS 4 progresses from step 114 to step 115 where State 3 is provided and the start-up sequence for engine 3 is initiated. During State 3 circuit 15 is deactivated and battery 5 is isolated from device 8. That is, only device 8 provides the cranking current to motor 7. Battery 5 does not, during State 3, provide any current to crank engine 3 nor to charge device 8.

It will be appreciated that the typically duration of State 2 is about 10 seconds to 20 seconds, and rarely more than 30 seconds. Accordingly, the design of battery 5 is able to be tailored for these typical loads, and not for these loads in addition to the simultaneous load of motor 7 during State 3 where there is a very high current demanded.

Following from the successful starting of engine 3 at step 115, EMS 4 progresses back to step 111 to operate engine 3 in State 1 and activates circuit 15 so that alternator 6 is able to recharge device 8, which will be at least partially discharged following from step 115. As State 2 only endures for a relatively short time, and engine 3 is still at or near its optimum operating temperature, the energy required from device 8 during step 115—that is, to allow for the starting sequence—is often modest in its absolute amount. However, due to the short time in which that energy is consumed it is important to have a high power capability such as that provided by a low ESR supercapactive device such as device 8. The low ESR is also particularly advantageous during the starting sequence where large currents are drawn from device 8. For the low ESR contributes not only to a low loss of energy and lower heat dissipation with device 8, but also to a low loss of effective voltage across device 8.

The steps of FIG. 8 continue to be implemented by EMS 4 until such time as the assessment at step 106 of FIG. 7 is positive.

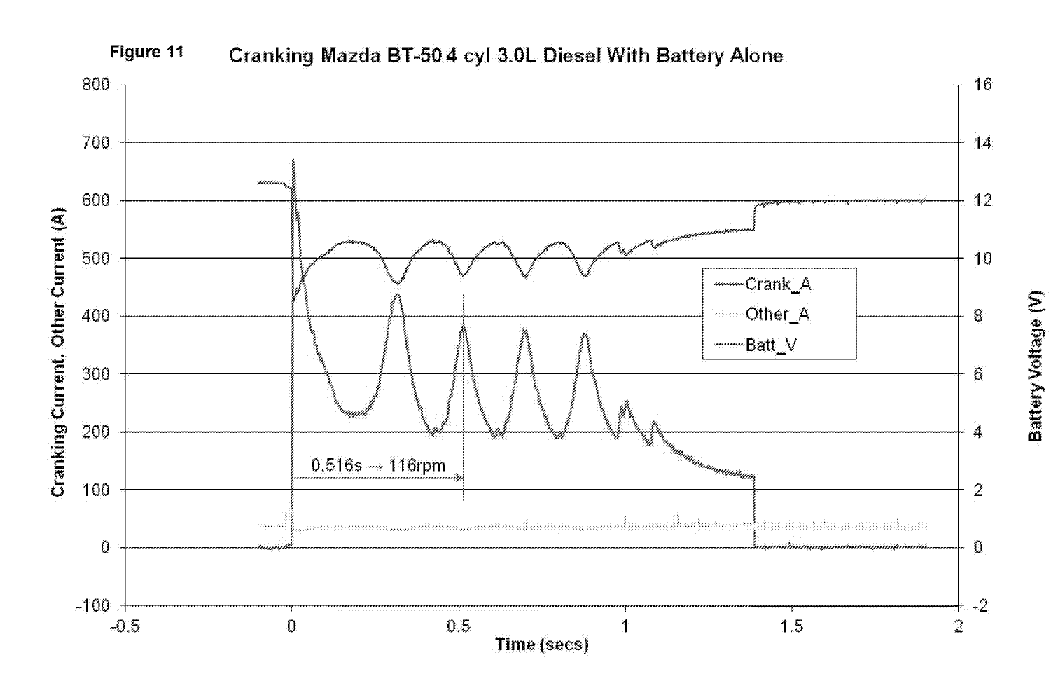

Reference is now made to FIG. 10, where corresponding features are denoted by corresponding reference numerals. More particularly, there is illustrated a control system 130 for an automotive engine in the form of engine 3. As referred to above, engine 3 has a starter motor 7, an alternator 6, and operates in a variety of states, including a start-up state and a run state. System 130 includes a control circuit, in the form of the combination of EMS 4 and circuit 15, for generating:
a) a first control signal to actuate motor 7 to crank the engine during the start-up state, wherein motor 7 draws electrical energy from supercapacitive device 8;
b) a second control signal to initiate the supply of electrical energy selectively from battery 5 to device 8 other than during the start-up state; and
c) a third control signal to initiate the selective supply of electrical energy during the run state from alternator 6 to device 8.

EMS 4 and circuit 15 are configured to cooperate and collectively define system 130 to provide the above functionality. In further embodiments (not shown) EMS 4 and circuit 15 are fully integrated, while in further embodiments still (also not shown) one or both of EMS 4 and circuit 15 are configured from disparate cooperating elements.

The control topology enabled by system 130 in FIG. 10 involves the following steps:
When engine 3 is operating normally: battery 5 is being charged; circuit 15 is active; device 8 either being charged to 14 Volts or being held at that voltage; hotel loads 12 are supplied from alternator 6; and the boardnet for car 1 is held at 14 Volts.
When car 1 has stopped: circuit 15 is OFF (that is, circuit 15 isolates battery 5 from device 8); battery 5 supplies hotel loads 12; and device 8 remains charged at 14 Volts.
When a restart is initiated: circuit 15 remains OFF; device 8 supplies the cranking current to motor 7 to allowing starting of engine 3 (that is, device 8 supplies all the cranking current and battery 5 provides no cranking current); and battery 5 continues to supply any required current to hotel load 12 at 12 Volts.
Following the restart of engine 3, system 130 returns to the first step specified above.

Points to note about the topology of the control system of FIG. 10 include: that battery 5 supplies the hotel load 12; device 8 provides all the cranking current; system 130 provides a current limit between battery 5 and device 8 primarily to ensure device 8 does not draw excessive currents when charging.

The current and voltage dynamics of a restart of an engine with a conventional battery set-up—that is, without a supercapacitive device—is illustrated in FIG. 11. The test was performed on a Mazda BT-50 SUV with a 4 cylinder 3.0 litre diesel engine. The waveforms are provided for the battery voltage (referred to as “Batt_V”), cranking current (referred to as “Crank_A”), and the current drawn by the hotel loads (referred to as “Other_A”). It will be noted that during the start-up phase the battery voltage drops considerably (sagging from 12.6 Volts to 8.6 Volts) as the battery attempts to provide the considerable cranking current in addition to the hotel loads. The total current peaks at about 670 Amps.

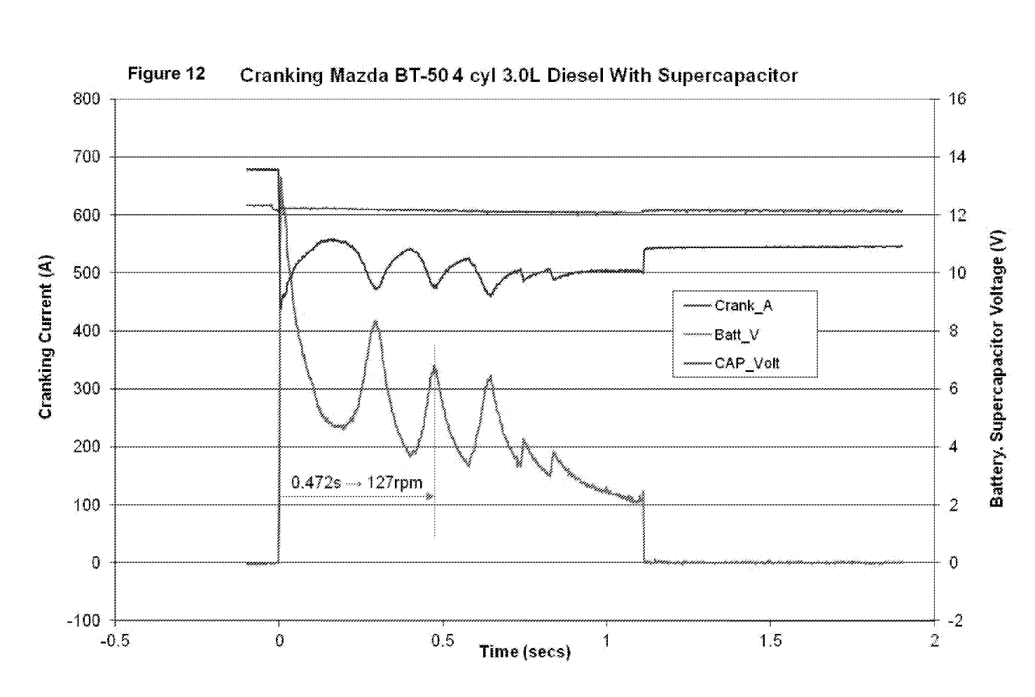

By contrast, when the same vehicle was fitted with a system 130, the voltage and current dynamics are superior, as is illustrated in FIG. 12. Particularly, the battery voltage remaining substantially unchanged during the period in which cranking current is supplied. The voltage provided by battery 5 also remains above 12 Volts as battery 5 provides none of the cranking current, all of which is supplied by the supercapacitive device. Moreover, engine 3 starts more quickly due to the increased capacity of the supercapacitor device to supply the required cranking current. In this specific example the engine started 21% faster than occurred sans system 130. As battery 5 is not called upon to provide the cranking current, it is able to more reliably supply the hotel loads and therefore more fully contribute to a seamless motoring experience for the operator of the car.

It will also be noted that the voltage waveform across the capacitive device is provided in FIG. 12 and is referred to as “CAP_Volt”. The voltage across the battery is also shown in FIG. 12 and labelled “Batt_V”.

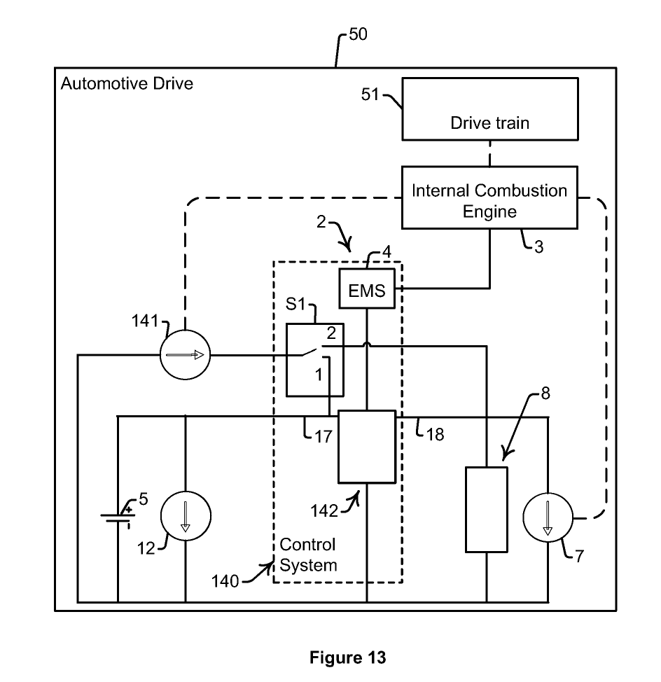

In another embodiment, as shown in FIG. 13, use is made of a topology similar to that of FIG. 10, although making use of a control system 140 for providing additional capabilities and functionalities, in this specific embodiment the additional capabilities and functionalities relate to the use of system 140 to manage a micro-hybrid operation of car 1. That is, in this embodiment car 1 is capable of regenerative braking and includes a generator 141 (a generator/alternator) to replace alternator 6 of FIG. 10. The current generated by that regenerative braking is supplied by generator 141 to control system 140 and, more specifically, it is supplied to a switch S1. This switch toggles between position 1 and position 2 as illustrated in FIG. 13. A further difference is that system 140 replaces circuit 15 of FIG. 10 with a converter circuit 142. This converter circuit, in this embodiment, is a bi-directional DC to DC converter and includes both bi-directional conversion of DC voltages and current limiting of those voltages. That is, the topology allows current flow from terminal 18 to terminal 17 and vice versa. This allows device 8 to selectively supply current to hotel load 12.

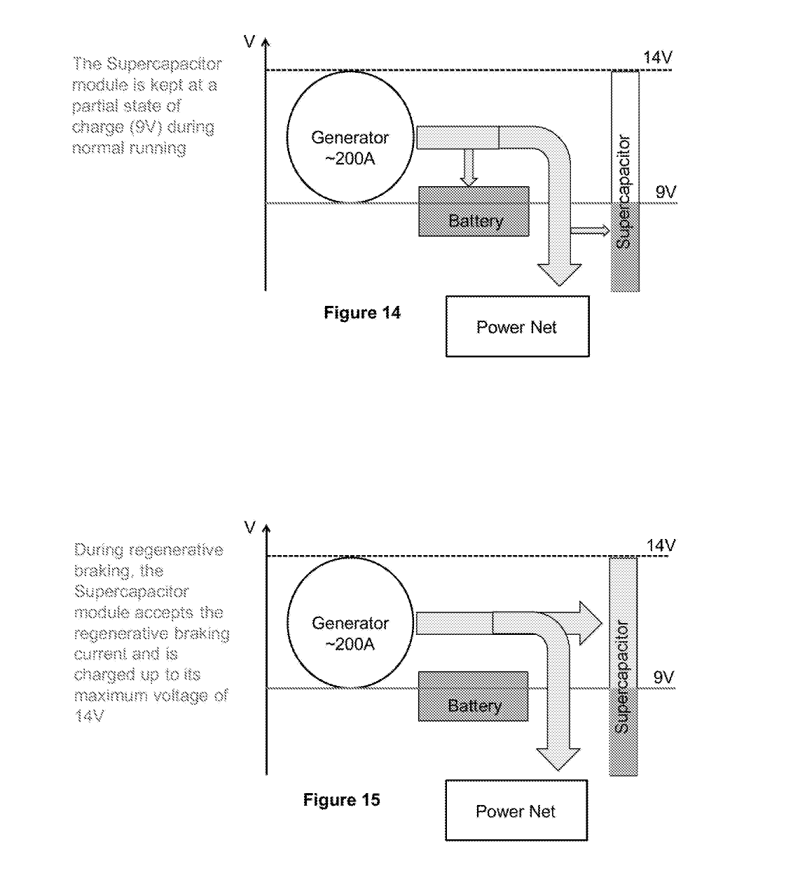

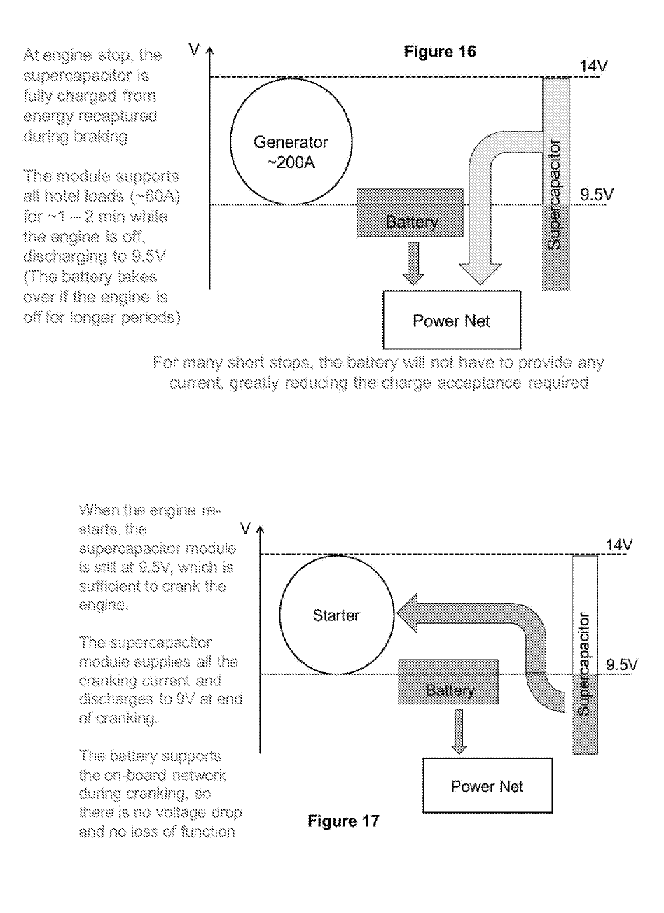

This micro-hybrid topology of FIG. 13 involves the following steps:
When engine 3 is operating normally: S1 is maintained in position; battery 5 is being charged; hotel load 12 is being supplied from generator 14; the boardnet for car 1 is held at 14 Volts; device 8 is held at about 9 Volts to leave headroom for energy capture during regenerative braking; and the DC to DC converter circuit 142 is OFF and, hence, device 8 is not being further charged. The energy flows that occur during this step in a specific embodiment are schematically illustrated in FIG. 14.
When regenerative braking; the DC to DC converter circuit remains OFF; switch S1 is toggled to position 2; battery 5 supplies the boardnet voltage; device 8 is charged up to its maximum voltage (which in: this embodiment is 14 Volts); switch S1 is toggled to position 1 when device 8 is fully charged; and generator 141 supplies the boardnet and charges battery 5. The energy flows that occur during this step in a specific embodiment are schematically illustrated in FIG. 15.
When car 1 then stops: device 8 discharges from 14 Volts to supply hotel load 12 at 12.8 Volts through the bi-directional DC to DC converter circuit 142; circuit 142 is turned off when device 8 discharges to the permitted minimum voltage (set at 9.5 Volts in this embodiment, which has been assessed as the voltage at which device 8 retains enough charge to reliably crank engine 3); and battery 5 then continues to supply hotel load 12. The energy flows that occur during this step in a specific embodiment are schematically illustrated in FIG. 16.
When the start sequence is initiated: device 8 is initially at 9.5 Volts (which, for this embodiment, is enough to reliably crank the engine with a large safety margin); and the entire cranking current for motor 7 is drawn from device 8. This operation typically results in device 8 discharging to about 9 Volts. The energy flows that occur during this step in a specific embodiment are schematically illustrated in FIG. 17,
Following the restart of engine 3, system 140 returns to the first step specified above.

During regenerative braking, device 8 is able to accept a high charge current and to store considerable amounts of energy. For the specific device 8 used in the above embodiment which is held at 9 Volts prior to the regenerative braking, it is possible to store up to about 14 KJ of recovered energy. The use of a higher capacitance device 8 would allow greater energy storage. By way of example, a 750 Farad supercapacitive device would store about 43 KJ. It will also be appreciated tha the supercapacitive module includes EDLC supercapacitive cells, while in other embodiments use is made of other supercapacitive cells, such as hybrid supercapacitive cells.

The operation of the the DC to DC converter 142 circuit during the period when engine 3 is off during a “stop” of the stop/start cycle, is such that the voltage supplied to terminal 17 is just above the fully charged battery voltage. This ensures that battery 5 does not supply the boardnet for car 1 and also so that battery 5 draws very little current. This operation ensures, for short stops, that battery 5 will not have to supply any current to load 12, which contributes to an extended life of battery 5.

It will also be appreciated that if, during the stop phase of engine 3, the maximum current that is can supplied by the DC to DC converter circuit 142 is less than the maximum current demanded by the boardnet, then the boardnet voltage will settle to a level where the battery supplies the difference between boardnet maximum and the maximum current provided by circuit 142. In this embodiment the maximum current that can be supplied by circuit 142 to the boardnet is determined by the peak current that can flow through the inductor in circuit 142 without saturating that inductor. In other embodiments, where circuit 142 is implemented differently, another design factor will provide the limit to the maximum current that that circuit can provide to the boardnet.

The topology provided by system 140 makes use of a circuit 142 that is, in this embodiment, a forward direction current limit—that is, when the device 8 is being charged—and a reverse direction DC to DC converter—when device 8 is being discharged to supply hotel load 12. The latter is an important distinction between the functionalities of systems 130 and 140, as system 140 allows device 8 selectively to supply hotel loads 12 while engine 3 is stopped during a stop/start operation. In the above embodiment, the selection is made while the voltage across device 8 remains about 9.5 Volts. In other embodiments a different selection is made, whether that is based upon a different minimum voltage across device 8, another criteria, a combination of criteria, or criteria that are dependent upon the circumstances at that time. For example, the minimum discharge voltage for device 8 is selected such that device 8, upon reaching that voltage, will still be able to reliably start engine 3. This voltage will depend upon a variety of factors, including the starter current profile for engine 3, and may be adjusted according to engine temperature, as a lower temperature will typically require a higher minimum voltage to be maintained on device 8 to provide the same safety margin for reliably cranking engine 3.

The DC to DC converter function of circuit 142—that is, when current is being discharged from device 8 and supplied to load 12—selectively acts in either a linear mode (when the voltage at terminal 18 is greater than the required voltage at terminal 17) and a boost mode (when the voltage at terminal 18 is less than the required voltage at terminal 17). As mentioned above, in this embodiment the voltage at terminal 18 during the stop of a stop/start operation is 12.8 Volts. Circuit 142 operates to maintain the voltage by selectively operating in the linear and boost mode as the voltage on device 8 falls from greater than 12.8 Volts to less than 12.8 Volts. In other embodiments the voltage to be maintained at terminal 17 is less than or greater to 12.8 Volts.

It will be appreciated that switch S1 is able to implemented in a variety of ways. In this automotive embodiment use is made of two pairs of back-to-back FETS. However, in other embodiments different components are used such as high current relays.

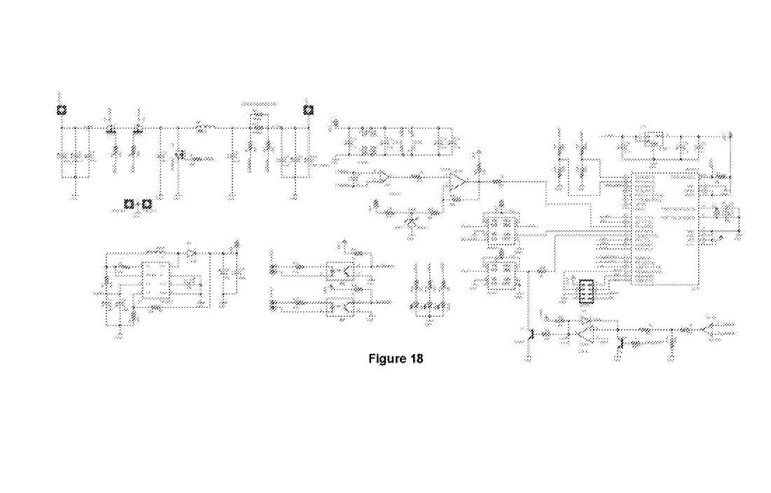

A exemplary embodiment of circuit 142 and switch S1 is provided in FIG. 18. This illustrated circuit operates both as a current limit—for current flowing from battery 5 to device 8—and selectively as a boost converter—for current flowing from device 8 to battery 5.

In broad terms the current limit function of the FIG. 18 circuit follows that of circuit 15 of FIG. 2. The main difference is that the control logic hardware used in circuit 15 is replaced by a microcontroller and associated hardware (as illustrated in FIG. 18). That is, while the current limit function operates on the same principles, the hardware and software control is differently implemented to provide that operation.

The operation of the current limit functionality of the circuit of FIG. 18 is as follows:
When the current limit function is first turned ON, Q1 & Q2 are turned ON, and Q3 turned OFF by the micro-controller through gate drive ICs 6 and 7.
The current ramps up through inductor L2,
Current flowing from the battery to the supercapacitive device is sensed through R9 in parallel with R10
The voltage across these resistors is by a factor of twenty by amplifier IC4.
The output voltage of IC4 is fed into a comparator with hysteresis, IC5.
When the current exceeds a predetermined threshold, the output of IC5 goes low. This is sensed by the microcontroller which turns OFF Q1 & Q2 and then turns ON Q3.

The body diode of Q3 allows current to flow through inductor L2 in the interval of a few microseconds after Q1 has been turned OFF, but Q3 has not yet turned ON.
The current through inductor L2 now decays.
When the output of IC5 goes low, its input threshold is reduced,
When the current decays such that the output of IC4 is greater than the threshold on comparator IC5, the output of IC5 switches to high,
This is sensed by the microcontroller which now turns OFF Q3 then turns ON Q1 and Q2.
The body diode of Q3 allows current to flow through the inductor L2 in the interval of a few microseconds after Q3 has been turned OFF.
The microcontroller senses signals from EMS 4 to turn the current limit ON/OFF. It also has an onboard A/D converter which senses the voltage across the supercapacitive device and the battery voltage. It turns OFF the current limit when the supercapacitor device reaches its maximum allowed voltage. This prevents over voltage if, for example, the alternator voltage is too high.
The microcontroller also turns the current limit OFF, or prevents its operation if the voltage across the supercapacitive device is greater than the battery voltage.

It will be appreciated by those skilled in the art that the current limit function of the circuit of FIG. 18 is able to be implemented differently and with different hardware combinations and software controls.

The operation of the boost functionality of the circuit of FIG. 18 is as follows:
The microcontroller senses an input signal from the EMS to indicate the car is in a stop-start state and the supercapacitive device is to supply the hotel loads until that device discharges to its minimum allowable voltage.
The microcontroller has an onboard A/D converter to measure the voltages across the supercapacitive device and the battery. If the voltage across the supercapacitive device is greater than the voltage across the battery, then Q3 is turned OFF and Q1 and Q2 are turned ON. The supercapacitive device then discharges into the boardnet until the voltage across the supercapacitive device is approximately the same as the battery voltage.
The power ratings of the sense resistors R9 and R10 are selected so they will fail if there is a short circuit on the boardnet (which would result in an attempt by the broadnet to draw excessive current).
When the voltage across the supercapacitive device is approximately equivalent to the voltage across the battery, the microcontroller starts a boost operation with the output voltage set slightly above the battery voltage. Typically the output voltage is about 0.3 Volts to 0.5 Volts higher than the battery voltage.
Q2 is turned ON, Q1 is turned OFF, Q3 is turned ON. The microcontroller starts a timer when Q3 is turned ON.
Current flows through inductor L2 and Q3 to ground. This current is sensed through R9 in parallel with R10 and a voltage proportional to this current is at the output of amplifier IC11.
A proportion of the voltage at IC11, set by the resistive divider R34 and R35 is fed to one input of comparator IC8.
When the maximum allowed inductor current is reached, the output of IC8 will go high. This turns on T1, which forces the gate drive to Q3 low, turning Q3 OFF.
When the output of IC8 goes high, diode D2 pulls the positive input of IC8 above the reference voltage at the negative input of IC8, locking the IC into this state.
The Lo-Hi transition of IC8 causes an interrupt to the microcontroller. In response, the microcontroller stops the Q3_ON timer, turns the gate drive for Q3 low, and then sets ILIMIT_RESET high to turn on T2. This, in turn, pulls the positive input of IC8 below the reference voltage at the negative input of IC8, forcing the output of IC8 low and unlocking this IC.
IC8 then turns Q1 ON. The body diode of Q1 allowes current flow through the inductor in the time after Q3 was turned OFF but before Q1 was turned ON.
The microcontroller records Q3_ON time for the calculation of Q1_ON time. Moreover, the microcontroller periodically measures voltages such as Vout (which is the battery across the battery) and Vscap (which is the voltage across the supercapacitive device).
The microcontroller now calculates the time Q1 remains ON (that is, Q1_ON time) and Q3 OFF, based upon:

Vout (desired)=1/(1−D)×Vscap

Where D=Q3_ON/(Q3_ON+Q1_ON)

When the Q1_ON time has expired, Q1 is turned OFF and then Q3 is turned ON and the cycle repeats.

The body diode of Q1 allows current to flow through the inductor in the period after Q1 is turned OFF but before Q3 is turned ON. Note that the microcontroller may have a minimum Q1_ON time which overrides the calculated value if it is smaller. This prevents the average current being too high.
The microcontroller, or the EMS, can turn the boost OFF when the supercapacitive device has discharged to its minimum value.

It will be appreciated by those skilled in the art that the boost function of the circuit of FIG. 18 is able to be implemented differently in other embodiments, and with different hardware combinations and software controls.

The use of the supercapacitive module to provide the cranking current and to be selectively charged by the battery (and to selectively supply the hotel loads) is included in Australian provisional patent application 2013902404. More particularly, expressly incorporated herein by way of cross reference from Australian patent application 2013902404 are: FIG. 2; the associated description provided for FIG. 2 at, for example, paragraph [00132] to [00149]; claims 66 to 68, 72 to 83, 85 to 87, 91 and 99; and the support provided in the description for those claims. Using the language of Australian patent application 2013902404, an embodiment of the invention has, as the ‘first energy storage system’, a supercapacitive device such as device 8, and a “second energy storage system” a battery such as battery 5.

The major advantages offered by the above embodiments include:
A longer operational life for the battery.
The battery not having to supply engine cranking loads at all. That is, neither alone nor in combination with the supercapacitive device.
The supercapacitive device always supplies the engine cranking loads.
The use of multiple energy storage devices.
The use of different types of energy storage devices.
The selective electrical isolation between the different energy storage devices during different states of operation.
The use of a high power low energy density energy storage device for powering the starter motor.
The use of the battery to power the hotel loads for typical stop durations in traffic (typically less than a few minutes) so the battery capacity, size, weight and cost are able to be considerably reduced from batteries currently used which must also supply engine cranking loads.
The use of the battery to supply energy to the supercapacitive device other than during the cranking of the engine.
The limiting of the charging current to the supercapacitive device.
Being responsive about the state of the stop/start function for determining whether or not the supercapacitive device is to be charged.
Being responsive to the level of charge of the supercapacitive device for determining it is to be further charged.
Being responsive to the anticipated next load demand on the supercapacitive device for determining if it should be further charged.
Allowing recovery of energy from regenerative braking to contribute to the operation of the start/stop functionality.
Allowing the supercapacitive device to selectively to supply the hotel loads.
Use of a single supercapacitive device to selectively crank the starter motor and supply the hotel loads.

### CONCLUSIONS AND INTERPRETATION

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein, Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network either wholly with the vehicle or partly within the vehicle and partly remote from the vehicle. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, a smart phone, a switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the terms “connected” or “coupled”, when used in the claims, should not be interpreted as being limited to direct connections only. The terms “coupled” and “connected,” along with their derivatives, may be used. The scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any flowcharts given are merely representative of procedures that may be used. Functionality may be added or deleted from the block diagrams and operations may be interchanged among functional blocks. Steps may be added or deleted to methods described within the scope of the present invention.

1. A control system for an automotive engine having a starter motor, an alternator, a start-up state, and a run state, the system including:
a control circuit for generating:
a first control signal to actuate a starter motor to crank the engine during the start-up state, wherein the starter motor draws electrical energy from a supercapacitive device;
a second control signal to initiate the supply of electrical energy selectively from a battery to the supercapacitive device other than during the start-up state; and
a third control signal to initiate the selectively supply of electrical energy during the run state from the alternator to the supercapacitive device.

2. A method for controlling an automotive engine having a starter motor, an alternator, a start-up state, and a run state, the method including:
actuating the starter motor to crank the engine during the start-up state, wherein the starter motor draws electrical energy from a supercapacitive device;
supplying electrical energy selectively from a battery to the supercapacitive device other than during the start-up state; and
selectively supplying electrical energy during the run state from the alternator to the supercapacitive device.

3. An automotive drive including: a drive unit for providing drive to a drive-train, the drive unit having a start-up state and a run state;
a starter unit for cranking the drive unit during the start-up state;
a first energy storage device for supplying electrical energy to the starter unit during the start-up state;
a second energy storage device for supplying electrical energy selectively to the first energy storage device other than during the start-up state; and
an electrical supply unit for selectively supplying electrical energy during the run state to the first energy storage device.

4. An automotive drive according to claim 3 wherein the electrical supply unit selectively supplies electrical energy during the run state to the second energy storage device.

5. An automotive drive according to claim 3 wherein the second energy storage device selectively supplies electrical energy to the first energy storage device prior to the start-up state.

6. An automotive drive according to claim 3 wherein the drive unit is an internal combustion engine and the electrical supply unit is an alternator that is mechanically driven by the engine during the run state.

7. An automotive drive according to claim 3 wherein the second energy storage device includes at least one electrochemical energy storage device.

8. An automotive drive according to claim 3 wherein the drive unit includes a stop state where it is not providing drive to the drive train, and the automotive drive includes a stop/start controller for selectively progressing the drive unit between the states.

9. An automotive drive according to claim 3 including an electrical load that draws current from the electrical supply unit during the run state.

10. An automotive drive according to claim 9 wherein the electrical load draws current from the second energy storage device during the stop state.

11. An automotive drive according to claim 10 wherein the electrical load draws current selectively from the second energy storage device during the start-up state.

12. An automotive drive according to claim 9 wherein the electrical load draws current selectively from the first energy storage device.
